(19) United States
(12) Patent Application Publication
(10) Pub. No.: US 2024/0152824 A1
(43) Pub. Date: May 9, 2024

(54) MANAGEMENT APPARATUS

(71) Applicant: TOYOTA JIDOSHA KABUSHIKI KAISHA, Toyota-shi Aichi-ken (JP)

(72) Inventors: Motofumi KAMIYA, Nagoya-shi Aichi-ken (JP); Hiroki TAKEISHI, Machida-shi Tokyo-to (JP)

(73) Assignee: TOYOTA JIDOSHA KABUSHIKI KAISHA, Toyota-shi Aichi-ken (JP)

(21) Appl. No.: 18/386,282

(22) Filed: Nov. 2, 2023

(30) Foreign Application Priority Data
Nov. 7, 2022 (JP) 2022-178436

(51) Int. Cl. G06Q 10/02; B60L 58/13; B60W 50/14; G01C 21/36

(52) U.S. Cl. CPC G06Q 10/02; B60L 58/13; B60W 50/14; G01C 21/3682; B60L 2250/16; B60W 2050/146; B60W 2510/244

(57) ABSTRACT

A management apparatus includes a controller configured to present a power supply service available to a vehicle to be power supplied based on a status of the power supply service, and accept a reservation for use of the power supply service from a user of the vehicle to be power supplied.

### CROSS-REFERENCE TO RELATED APPLICATION

This application claims priority to Japanese Patent Application No. 2022-178436, filed on Nov. 7, 2022, the entire contents of which are incorporated herein by reference.

### TECHNICAL FIELD

The present disclosure relates to a management apparatus for power supply vehicles.

### BACKGROUND

A system for charging electric vehicles (EVs) by placing quick charging stations or mobile power supply vehicles for quick charging of the EVs at EV users' business bases or places at which the EV users stop off is known (see, for example, Patent Literature (PTL) 1).

### CITATION LIST

### Patent Literature

PTL 1: JP 3123576 U

### SUMMARY

The convenience of users of power supply services needs to be improved.

It would be helpful to improve the convenience of users of power supply services.

A management apparatus according to an embodiment of the present disclosure includes a controller. The controller is configured to:
present a power supply service available to a vehicle to be power supplied, based on a status of the power supply service; and
accept a reservation for use of the power supply service from a user of the vehicle to be power supplied.

According to a management apparatus according to an embodiment of the present disclosure, the convenience of users of power supply services can be improved.

### BRIEF DESCRIPTION OF THE DRAWINGS

In the accompanying drawings:

FIG. 1 is a block diagram illustrating an example configuration of a management system according to an embodiment;

FIG. 2 is a diagram illustrating an example of display of available power supply services;

FIG. 3 is a flowchart illustrating an example procedure of a management method executed by a management apparatus; and

FIG. 4 is a flowchart illustrating an example procedure of a management method executed by a terminal apparatus.

### DETAILED DESCRIPTION

(Example Configuration of Management System 1)

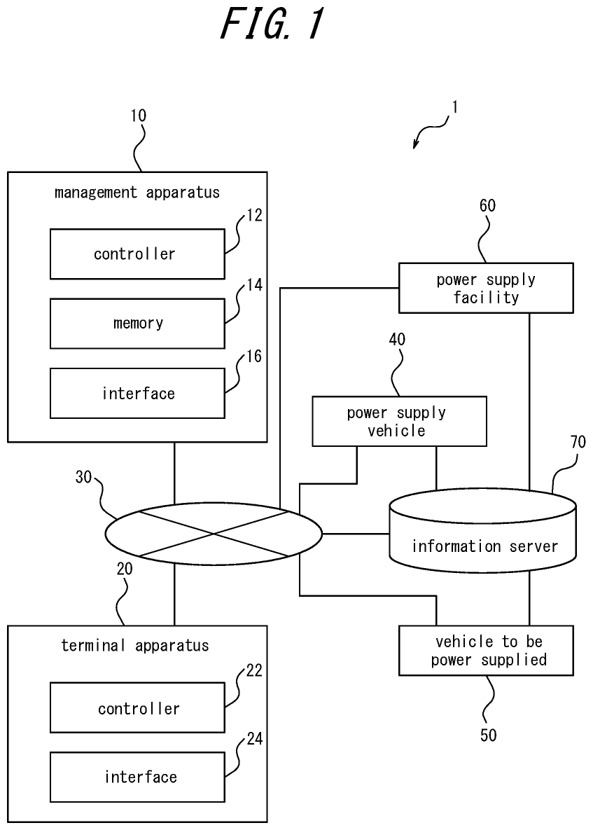

As illustrated in FIG. 1, a management system 1 according to an embodiment includes a management apparatus 10, a terminal apparatus 20, a power supply vehicle 40, a vehicle 50 to be power supplied, and a power supply facility 60. The management system 1 provides a power supply service that supplies power to a battery of the vehicle 50 to be power supplied from the power supply vehicle 40 or the power supply facility 60. A specific example configuration of the management system 1 will be described below.

<Management Apparatus 10>

The management apparatus 10 includes a controller 12, a memory 14, and an interface 16.

The controller 12 controls at least one component of the management apparatus 10. The controller 12 may be configured to include at least one processor. The “processor” is a general purpose processor, a dedicated processor specialized for specific processing, or the like in the present embodiment but not limited to these. The controller 12 may be configured to include at least one dedicated circuit. The dedicated circuit may include, for example, a field-programmable gate array (FPGA) or an application specific integrated circuit (ASIC). The controller 12 may be configured with the dedicated circuit instead of the processor, or may be configured with the dedicated circuit along with the processor.

The memory 14 may be configured to include a semiconductor memory, a magnetic memory, an optical memory, or the like, for example, but not limited to these. The memory 14 may function as, for example, a main memory, an auxiliary memory, or a cache memory. The memory 14 may be configured to include an electromagnetic storage medium, such as a magnetic disk. The memory 14 may be configured to include a non-transitory computer readable medium. The memory 14 stores any information or program to be used for operations of the management apparatus 10. For example, the memory 14 may store a system program, an application program, or the like. The memory 14 may be included in the controller 12.

Information, data, or the like is outputted from and inputted to the controller 12 through the interface 16. The interface 16 may include a communication module configured to be communicable to other devices, such as the terminal apparatus 20, via a network 30. The communication module may be, for example, compliant with a mobile communication standard, such as the 4th Generation (4G) standard or the 5th Generation (5G) standard. The communication module may be compliant with a communication standard, such as a Local Area Network (LAN). The communication module may be compliant with a wired or wireless communication standard. The communication module is not limited to these examples and may be compliant with various communication standards. The interface 16 may be configured to be able to connect to a communication module.

The interface 16 may be configured with an input device for accepting input of information, data, or the like from a user. The input device may be configured with, for example, a touch panel, a touch sensor, or a pointing device such as a mouse. The input device may be configured with a physical key. The input device may be configured with an audio input device, such as a microphone. The interface 16 may be configured to be able to connect to an external input device. The interface 16 may be configured to be able to acquire, from the external input device, information or data input to the external input device.

The interface 16 may be configured to include an output device that outputs information, data, or the like to the user. The output device may include, for example, a display device that outputs visual information, such as images, letters, or graphics. The display device may be configured with, for example, a Liquid Crystal Display (LCD), an organic or inorganic Electro-Luminescence (EL) display, a Plasma Display Panel (PDP), or the like. The display device is not limited to the above displays and may be configured with various other types of displays. The display device may be configured with a light emitting device, such as a Light Emitting Diode (LED) or a Laser Diode (LD). The display device may be configured with various other devices. The output device may include, for example, an audio output device, such as a speaker, that outputs audio information, such as voice. The output device is not limited to the above examples and may include various other devices. The interface 16 may be configured to be able to connect to an external output device. The interface 16 may be configured to be able to output information or data to the external output device.

The management apparatus 10 may be configured to include a single server apparatus or a plurality of server apparatuses capable of communicating with each other. The management apparatus 10 may be realized as a cloud server.

<Terminal Apparatus 20>

The terminal apparatus 20 is communicably connected to the management apparatus 10 and the like via the network 30. The terminal apparatus 20 includes a controller 22 and an interface 24.

The controller 22 may be configured with one or more processors or one or more dedicated circuits. The controller 22 may be configured to be identical or similar to the controller 12 of the management apparatus 10. The controller 22 may be configured to include a memory. The memory may be configured to be identical or similar to the memory 14 of the management apparatus 10.

The interface 24 may be configured to include an input device, an output device, or a communication device. The interface 24 may be configured to be identical or similar to the interface 16 of the management apparatus 10. The interface 24 may be wired or wirelessly communicably connected to the management apparatus 10 and the like. The interface 24 may include a display device. In the case of including the display device as the interface 24, the terminal apparatus 20 may function as a display apparatus.

The terminal apparatus 20 may be carried by a user or may be installed in a predetermined position. The terminal apparatus 20 may be configured as a mobile terminal, such as a smartphone or a tablet, or a Personal Computer (PC), such as a notebook PC or a tablet PC. The terminal apparatus 20 is not limited to the above examples and may include various devices. The number of terminal apparatuses 20 included in the management system 1 is not limited to one and may be two or more.

<Power Supply Vehicle 40 and Vehicle 50 to be Power Supplied>

The vehicle 50 to be power supplied may be an electric vehicle that is driven using battery power. The electric vehicle may include a Hybrid Electric Vehicle (HEV), a Plug-in Hybrid Electric Vehicle (PHEV), a Fuel Cell Electric Vehicle (FCEV), or a Battery Electric Vehicle (BEV). The vehicle 50 to be power supplied is also simply referred to as a vehicle. The number of vehicles 50 to be power supplied that use power supply services provided by the management system 1 is not limited to one, but may be two or more.

The power supply vehicle 40 may be an engine vehicle or an electric vehicle. The number of power supply vehicles 40 managed by the management system 1 is not limited to one, but may be two or more.

The power supply vehicle 40 may be equipped with a power supply apparatus that supplies power to the vehicle 50 to be power supplied. The power supply apparatus may be equipped with at least one battery. The power supply apparatus may be equipped with a converter, an inverter, or the like that controls current or voltage to be supplied from the battery to the vehicle 50 to be power supplied. The power supply vehicle 40 may be configured to supply power from the battery of the power supply vehicle 40 to the vehicle 50 to be power supplied. The power supply vehicle 40 may be equipped with a power supply cable or a power supply connector that connects to the vehicle 50 to be power supplied. The power supply vehicle 40 may be equipped with a device configured to provide a non-contact power supply to the vehicle 50 to be power supplied. A task of supplying power from the power supply vehicle 40 to the vehicle 50 to be power supplied may be performed by a worker of the power supply vehicle 40 or by a user of the vehicle 50 to be power supplied. The power supply vehicle 40 may be configured to automatically supply power to the vehicle 50 to be power supplied.

The power supply vehicle 40 or the vehicle 50 to be power supplied may be equipped with a communication device that is communicably connected to the management apparatus 10, the terminal apparatus 20, or the like. The power supply vehicle 40 or the vehicle 50 to be power supplied may be configured to be operated by a driver or may be configured to travel by automated driving. The vehicle 50 to be power supplied is also simply referred to as a vehicle.

The power supply vehicle 40 or the vehicle 50 to be power supplied may further include a location information detector that acquires location information. The location information detector may output, to the management apparatus 10, the location information on the power supply vehicle 40 or the vehicle 50 to be power supplied. The location information detector may be configured to include a receiver compliant with a satellite positioning system. The receiver compliant with the satellite positioning system may be configured to include, for example, a Global Positioning System (GPS) receiver or the like.

<Power Supply Facility 60>

The power supply facility 60 is configured to charge the battery of the vehicle 50 to be power supplied. The power supply facility 60 may be equipped with a converter, an inverter, or the like to control current or voltage to be suppled to the battery of the vehicle 50 to be power supplied. The power supply facility 60 may be equipped with a processor or dedicated circuitry that controls battery charging. The power supply facility 60 may be equipped with a power supply cable or a power supply connector that connects to the vehicle 50 to be power supplied. The power supply facility 60 may be equipped with a device configured to provide a non-contact power supply to the vehicle 50 to be power supplied. The power supply facility 60 may be connected to a power grid and charge the battery of the vehicle 50 to be power supplied with power supplied from the power grid. The power supply facility 60 may be equipped with a power source, such as a battery or a generator, to charge the battery of the vehicle 50 to be power supplied with power supplied by the power source.

The power supply facility 60 may be equipped with a communication device that is communicably connected to the management apparatus 10, the terminal apparatus 20, or the like. The communication device may output detection results of power supply to the vehicle 50 to be power supplied, to the management apparatus 10, the terminal apparatus 20, or the like.

<Information Server 70>

The management system 1 according to the present embodiment may further include an information server 70. In some embodiments, the information server 70 may be omitted. The information server 70 may acquire information regarding the power supply vehicle 40, the power supply facility 60, or the vehicle 50 to be power supplied, and store the information as a database or the like. The information server 70 may output the information regarding the power supply vehicle 40, the power supply facility 60, or the vehicle 50 to be power supplied, to the management apparatus 10, the terminal apparatus 20, or the like. The information server 70 may be equipped with a processor or the like that functions as a controller. The information server 70 may be equipped with a memory or the like that functions as a memory. The information server 70 may be equipped with a communication device configured to be communicable with the management apparatus 10, the terminal apparatus 20, or the like. The information server 70 may be configured to include a single server apparatus or a plurality of server apparatuses capable of communicating with each other. The information server 70 may be realized as a cloud server.

(Operation Example of Management System 1)

In the management system 1 according to the present embodiment, the management apparatus 10 extracts the power supply vehicle 40 or the power supply facility 60, as a power supply service available to a user who owns or manages the vehicle 50 to be power supplied. The management apparatus 10 notifies the user of the extracted available power supply service. The management apparatus 10 may notify the user of a time or location at which the power supply service is available. The terminal apparatus 20 accepts, from the user, input for the power supply service to be reserved for use. When the user's reservation is established, the management apparatus 10 manages reservations of other vehicles so that the power supply vehicle 40 or the power supply facility 60 can supply power to the vehicle 50 to be power supplied, at the time specified by the reservation. The management apparatus 10 manages operations of the power supply vehicle 40 so that the power supply vehicle 40 travels to the location specified by the reservation at the time specified by the reservation. Specific example operations of the management system 1 will be described below.

<Extraction of Available Power Supply Services>

The controller 12 of the management apparatus 10 may extract, as an available power supply service, a power supply facility 60 located within a range in which the vehicle 50 to be power supplied can move. The range in which the vehicle 50 to be power supplied can move is also referred to as a movable range. The controller 12 may extract, among power supply facilities 60, a power supply facility 60 that can provide a power supply service to the vehicle 50 to be power supplied within a predetermined time frame, as an available power supply service. The controller 12 may acquire a remaining charge (state of charge: SOC) of the battery of the vehicle 50 to be power supplied. The controller 12 may extract the available power supply services when the remaining charge is less than a predetermined level. The controller 12 does not need to extract the available power supply services when the remaining charge is greater than or equal to the predetermined level. The controller 12 may extract the available power supply services regardless of the remaining charge.

The controller 12 may extract, as an available power supply service, a power supply facility 60 located within a range in which the vehicle 50 to be power supplied can move. The controller 12 may extract, as an available power supply service, a power supply vehicle 40 that can move to the current location of the vehicle 50 to be power supplied or the movable range of the vehicle 50 to be power supplied. The power supply vehicle 40 that can move to the vehicle 50 to be power supplied is also referred to as rush-ready power supply vehicle 40. The controller 12 may estimate a location of the vehicle 50 to be power supplied at a predetermined time, and extract a power supply vehicle 40 that can rush to the vehicle 50 to be power supplied at the predetermined time, as an available power supply service. The controller 12 may extract an available power supply service based on the availability of the power supply facility 60 or the power supply vehicle 40. The controller 12 may extract, among power supply vehicles 40, a power supply vehicle 40 that can provide a power supply service to the vehicle 50 to be power supplied within a predetermined time frame, as an available power supply service. The controller 12 may extract, among power supply vehicles 40, a power supply vehicle 40 that has excess capacity to supply power to the vehicle 50 to be power supplied, as an available power supply service.

The controller 12 may extract available power supply services within a range that includes the current location of the vehicle 50 to be power supplied. When the user is located away from the vehicle 50 to be power supplied, the controller 12 may extract available power supply services within a range that includes the user's current location. The controller 12 may extract available power supply services in a range including a location specified on a map by the user or in a range specified on the map by the user, regardless of the locations of the vehicle 50 to be power supplied and the user. The controller 12 may accept input from the user to select either the range that includes the current location of the vehicle 50 to be power supplied or the user or the specified range, as the range from which available power supply services are extracted. The user selected information that identifies the range of the available power supply services to be extracted is also referred to as setting information.

The controller 12 may set the location of the power supply facility 60 extracted as the available power supply service or the location to which the power supply vehicle 40 can move, as the location at which the power supply service can be provided to the vehicle 50 to be power supplied. The location at which the power supply service can be provided to the vehicle 50 to be power supplied is also referred to as an available power supply location. The available power supply location may be represented as a specific point or as a specific range. The controller 12 may notify the user of the set available power supply location. The controller 12 may notify the user of the available power supply location by displaying the available power supply location on a display device of the interface 16. The controller 12 may output the available power supply location to the terminal apparatus 20. The controller 22 of the terminal apparatus 20 may notify the user of the available power supply location by displaying the available power supply location on a display device (display apparatus) of the interface 24.

The controller 12 may display an alarm to the user when the number of available power supply services is less than a predetermined value. In this way, the user can recognize the need to secure a charging of the vehicle 50 to be power supplied as soon as possible. Consequently, the convenience of the user is improved.

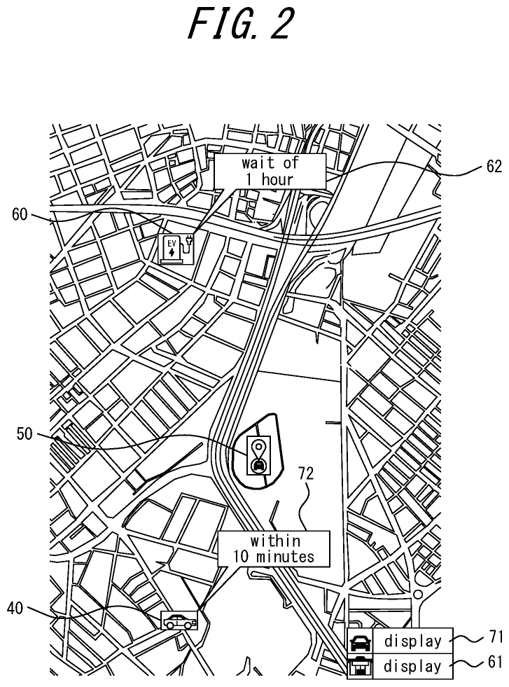

As illustrated in FIG. 2, the controller 12 may generate an image that displays available power supply locations on a map. The controller 12 may display, on the map, the location of the power supply facility 60 or the location of the power supply vehicle 40 that can supply power to the vehicle 50 to be power supplied. The controller 12 may display, on the map, the current location of the vehicle 50 to be power supplied. The controller 12 may display, on the map, a range in which the vehicle 50 to be power supplied can move. The controller 12 may display, on the map, the current location of the user who is away from the vehicle 50 to be power supplied. The controller 12 may output the generated map image to the terminal apparatus 20. The controller 22 of the terminal apparatus 20 may display the map on the display device of the interface 24. The controller 22 of the terminal apparatus 20 may generate an image that displays the available power supply locations on the map and display the image on the display device of the interface 24.

The controller 12 may display an operation interface 61 to select the display of the power supply facility 60. The controller 12 displays the power supply facility 60 when the display of the power supply facility 60 is selected in the operation interface 61, and does not display the power supply facility 60 when the non-display of the power supply facility 60 is selected in the operation interface 61. The controller 12 may display an operation interface 71 to select the display of the power supply vehicle 40. The controller 12 displays the power supply vehicle 40 when the display of the power supply vehicle 40 is selected in the operation interface 71, and does not display the power supply vehicle 40 when the non-display of power supply vehicle 40 is selected in the operation interface 71. In this way, the user can check the available power supply services for each type of power supply service. Consequently, the convenience of the user is improved. The operation interface 61 or 71 may be displayed by the controller 22 of the terminal apparatus 20. Information specifying whether to display the power supply facility 60 or the power supply vehicle 40 shall be included in the setting information.

The controller 12 may vary the manner of displaying the power supply services when the user is on board the vehicle 50 to be power supplied or the user is located within a predetermined range from the vehicle 50 to be power supplied, from the manner of displaying the power supply services when the user is located outside the predetermined range from the vehicle 50 to be power supplied. The controller 12 may display an operation interface that accepts input from the user to select the manner of displaying the power supply services. The operation interface may be displayed by the controller 22 of the terminal apparatus 20. Information specifying the manner of displaying the power supply services shall be included in the setting information.

The controller 12 may display a comment 62 that notifies the user of a time at which the power supply facility 60 can provide a power supply service to the vehicle 50 to be power supplied. The comment 62 illustrated in FIG. 2 indicates that the vehicle 50 to be power supplied needs to wait one hour before the time at which the power supply facility 60 is ready to provide the power supply service. The controller 12 may display a waiting time as the comment 62, or the number of vehicles 50 that are waiting for power supply services to be provided by the power supply facility 60. The controller 12 may display a comment 72 that notifies a time at which the power supply vehicle 40 can provide a power supply service to the vehicle 50 to be power supplied. The comment 72 illustrated in FIG. 2 indicates that the power supply vehicle 40 can provide the power supply service within 10 minutes. In this way, the user can be provided with decision criteria for selecting a power supply service. Consequently, the convenience of the user is improved. The comment 62 or 72 may be displayed by the controller 22 of the terminal apparatus 20.

<Reservation for Use of Power Supply Service>

The controller 12 extracts available power supply services and outputs the available power supply services to the terminal apparatus 20. The controller 22 of the terminal apparatus 20 presents the available power supply services to the user by displaying the available power supply services on the display device of the interface 24. The controller 22 may display the available power supply services on a map as illustrated in FIG. 2 or in another manner, such as a list. The controller 22 accepts, from the input device of the interface 24, input by the user to select a desired power supply service from among the power supply services presented to the user. The controller 22 outputs, to the management apparatus 10, information identifying the power supply service selected by the user. The controller 22 may accept, from the input device of the interface 24, input of a desired time to use the power supply service. The controller 22 may output the desired time to the management apparatus 10. The controller 22 may accept, from the input device of the interface 24, input of a desired point to use the power supply service by a power supply vehicle 40. The controller 22 may output the desired point to the management apparatus 10.

The controller 12 establishes a reservation so that the user can use the selected power supply service. In a case in which the user has specified the time to provide the power supply service, the controller 12 establishes the reservation when the power supply service is available at the specified time. In a case in which the user has specified the point to provide the power supply service, the controller 12 establishes the reservation when the power supply vehicle 40 can move to the specified point. The controller 12 does not have to establish the reservation when there is no power supply service that meets the conditions specified by the user. The controller 12 outputs a result of the reservation being established or not established to the terminal apparatus 20. The terminal apparatus 20 displays the reservation result and notifies the user. When the reservation has not been established, the controller 22 may accept, from the input device of the interface 24, input by the user to re-select a power supply service or re-specify a provision time or a provision point.

<Operations of Power Supply Vehicle 40>

In a case in which a power supply service is provided by the power supply vehicle 40, the controller 12 may generate an operation schedule for the power supply vehicle 40 so that the power supply vehicle 40 can provide the power supply service based on the conditions specified by the user. The controller 12 may output the operation schedule to the power supply vehicle and manage the operations of the power supply vehicle 40. When the power supply vehicle 40 is operated by a driver, the controller 12 may notify the driver of the operation schedule. When the power supply vehicle 40 is operated by automated driving, the controller 12 may output the operation schedule or control information to a control apparatus of the power supply vehicle 40.

<Example Procedure for Management Method>

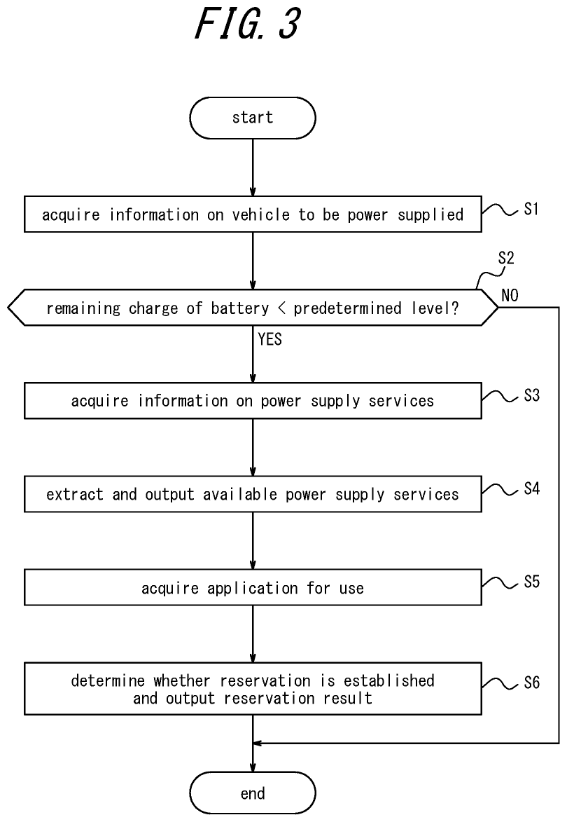

In the management system 1 according to the present embodiment, the controller 12 of the management apparatus 10 may perform a management method including a procedure of a flowchart exemplified by FIG. 3, to provide a power supply service. The management method may be implemented as a management program to be executed by a processor or the like constituting the controller 12. The management program may be stored on a non-transitory computer readable medium.

The controller 12 acquires information on the vehicle 50 to be power supplied (step S1). The controller 12 determines whether a remaining charge of the battery of the vehicle 50 to be power supplied is less than a predetermined level (step S2). When the remaining charge of the battery of the vehicle 50 to be power supplied is not less than the predetermined level (step S2: NO), that is, when the remaining charge of the battery of the vehicle 50 to be power supplied is greater than or equal to the predetermined level, the controller 12 terminates execution of the procedure of the flowchart in FIG. 3.

When the remaining charge of the battery of the vehicle 50 to be power supplied is less than the predetermined level (step S2: YES), the controller 12 acquires information on the power supply vehicle 40 or the power supply facility 60, as information on power supply services (step S3). The controller 12 extracts, based on the information on the power supply services, power supply services available to the user of the vehicle 50 to be power supplied, and outputs the available power supply services to the terminal apparatus 20 (step S4). The controller 12 acquires an application for use of a power supply service from the terminal apparatus 20 (step S5). The controller 12 determines whether a reservation for the power supply service is established and outputs a reservation result to the terminal apparatus 20 to notify the user (step S6). After performing the process of step S6, the controller 12 ends the procedure of the flowchart in FIG. 3.

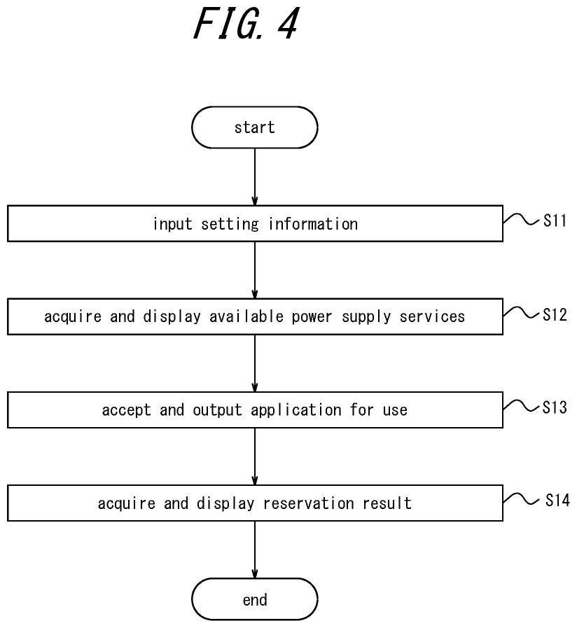

To provide the power supply service, the controller 22 of the terminal apparatus 20 may perform a management method including a procedure of a flowchart exemplified by FIG. 4. The management method may be implemented as a management program to be executed by a processor or the like constituting the controller 12. The management program may be stored on a non-transitory computer readable medium.

The controller 22 accepts input of setting information at the input device of interface 24 (step S11). The setting information may include information identifying a user-selected range from which available power supply services are extracted. The setting information may include information specifying whether the power supply facility 60 or the power supply vehicle is displayed. The setting information may include various other types of information, without being limited to these examples. The controller 22 retrieves available power supply services extracted by the management apparatus 10 and displays the available power supply services on the display device of the interface 24 (step S12). The controller 22 accepts an application for use of a power supply service from the user with the input device of the interface 24 and outputs the application for use to the management apparatus (step S13). The controller 22 acquires a result of a reservation being established or not established from the management apparatus 10 and displays the result on the display device of the interface 24 (step S14). After performing the process of step S14, the controller 22 ends the procedure of the flowchart in FIG. 4.

### SUMMARY

As described above, the management system 1 according to the present embodiment can present power supply services available to a vehicle to be power supplied based on the status of the power supply services, and accept a reservation for use of a power supply service from a user of the vehicle to be power supplied. As a comparative example, a system in which a user makes a reserve for use of a power supply service by telephone, e-mail, chat, or the like can be considered. The comparative example system has difficulty in coordinating the power supply service with the location of the vehicle 50 to be power supplied or the location of the user. On the other hand, the management system 1 according to the present embodiment can present the available power supply services considering the location of the vehicle 50 to be power supplied or the location of the user. In this way, the user can easily make the reservation for the power supply service. Consequently, the convenience of the user is improved.

### Another Embodiment

An example configuration of the management system 1 according to another embodiment will be described below.

<Suitability of Power Supply Service>

The charging characteristics of the vehicle 50 to be power supplied may vary depending on the specifications of the vehicle 50 to be power supplied. The charging characteristics of the vehicle 50 to be power supplied may vary depending on the specifications of the power supply facility 60 or the power supply vehicle 40. The charging characteristics of the vehicle 50 to be power supplied may vary depending on the combination of the specifications of the vehicle 50 to be power supplied and the specifications of the power supply facility 60 or the power supply vehicle 40. The charging characteristics may include time required to charge the vehicle 50 to be power supplied, energy efficiency during charging, or the like. For the energy efficiency, the lower the power loss during charging, the higher the energy efficiency. The higher the energy efficiency, the less electrical energy is required for charging.

The controller 12 of the management apparatus 10 may extract power supply services suitable for the vehicle 50 to be power supplied so that the charging time can be reduced and the energy efficiency during charging can be improved. The controller 12 may calculate the suitability of the power supply services for the vehicle 50 to be power supplied, for the combination of the vehicle 50 to be power supplied and each power supply service, such as the power supply facility 60 or the power supply vehicle 40. In the present embodiment, the controller 12 calculates a larger value of the suitability as the charging time is reduced. In addition, the controller 12 calculates a larger value of the suitability as the energy efficiency is improved. The controller 12 may calculate a smaller value of the suitability according to the reduction in the charging time or improvement in the energy efficiency.

The controller 12 may extract available power supply services based on the values of the suitability. For example, the controller 12 may extract a predetermined number of power supply services in decreasing order of the value of the suitability. The controller 12 may extract power supply services with values of the suitability greater than or equal to a predetermined value. The controller 12 may extract available power supply services regardless of the values of the suitability and display the extracted power supply services together with the values of the suitability. The controller 12 may display the power supply services in different manners depending on the values of the suitability.

Since the controller 12 presents the available power supply services in consideration of the suitability, the user can select a power supply service so as to reduce the charging time or charging cost. Consequently, the convenience of the user is improved.

While embodiments of the present disclosure have been described with reference to the drawings and examples, it is to be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or divided.

1. A management apparatus comprising a controller configured to:
present a power supply service available to a vehicle to be power supplied, based on a status of the power supply service; and
accept a reservation for use of the power supply service from a user of the vehicle to be power supplied.

2. The management apparatus according to claim 1, wherein the controller is configured to display the power supply service available to the vehicle to be power supplied, based further on a status of the vehicle to be power supplied.

3. The management apparatus according to claim 2, wherein the controller is configured to display the power supply service and accept the reservation for use of the power supply service from the user of the vehicle to be power supplied when a remaining charge in a battery of the vehicle to be power supplied is less than a predetermined level.

4. The management apparatus according to claim 1, wherein the controller is configured to display, based on setting information entered by the user of the vehicle to be power supplied, a power supply facility located within a movable range of the vehicle to be power supplied or a power supply vehicle that can move to the movable range of the vehicle to be power supplied, as the power supply service available to the vehicle to be power supplied.

5. The management apparatus according to claim 2, wherein the controller is configured to display, based on setting information entered by the user of the vehicle to be power supplied, a power supply facility located within a movable range of the vehicle to be power supplied or a power supply vehicle that can move to the movable range of the vehicle to be power supplied, as the power supply service available to the vehicle to be power supplied.

6. The management apparatus according to claim 3, wherein the controller is configured to display, based on setting information entered by the user of the vehicle to be power supplied, a power supply facility located within a movable range of the vehicle to be power supplied or a power supply vehicle that can move to the movable range of the vehicle to be power supplied, as the power supply service available to the vehicle to be power supplied.

7. The management apparatus according to claim 1, wherein the controller is configured to vary a manner of displaying the power supply service, according to a value of suitability of the power supply service for the vehicle to be power supplied.

8. The management apparatus according to claim 2, wherein the controller is configured to vary a manner of displaying the power supply service, according to a value of suitability of the power supply service for the vehicle to be power supplied.

9. The management apparatus according to claim 3, wherein the controller is configured to vary a manner of displaying the power supply service, according to a value of suitability of the power supply service for the vehicle to be power supplied.

10. The management apparatus according to claim 4, wherein the controller is configured to vary a manner of displaying the power supply service, according to a value of suitability of the power supply service for the vehicle to be power supplied.

11. The management apparatus according to claim 5, wherein the controller is configured to vary a manner of displaying the power supply service, according to a value of suitability of the power supply service for the vehicle to be power supplied.

12. The management apparatus according to claim 6, wherein the controller is configured to vary a manner of displaying the power supply service, according to a value of suitability of the power supply service for the vehicle to be power supplied.
